(19) United States
(12) Patent Application Publication
(10) Pub. No.: US 2024/0387940 A1
(43) Pub. Date: Nov. 21, 2024

(54) BATTERY CABINET

(71) Applicant: JUSTRITE MANUFACTURING COMPANY, LLC DBA JUSTRITE SAFETY GROUP, Deerfield, IL (US)

(72) Inventors: David W. Harvey, Wellsburg, WV (US); Eric R. Johnson, Washington, DC (US); Christopher R. March-Jones, Cheadle (GB); Ronald F. Auer, Jr., Mattoon, IL (US); Jeffrey D. Bunting, Charleston, IL (US); Mareen E. J. Walsh, Richmond, OH (US); Howard E. Edgreen, Carnegie, PA (US); August A. Chasey, Peachtree City, GA (US); Michael W. Bykowski, Lindenhurst, IL (US)

(73) Assignee: JUSTRITE MANUFACTURING COMPANY, LLC DBA JUSTRITE SAFETY GROUP, Deerfield, IL (US)

(21) Appl. No.: 18/665,975

(22) Filed: May 16, 2024

Related U.S. Application Data
(60) Provisional application No. 63/467,712, filed on May 19, 2023.

(51) Int. Cl. H01M 50/383; A62C 2/06; A62C 2/18; A62C 3/16; F16L 59/06; H01M 10/46; H01M 10/613; H01M 10/627; H01M 10/6563

(52) U.S. Cl. CPC H01M 50/383; A62C 2/065; A62C 2/18; A62C 3/16; F16L 59/06; H01M 10/46; H01M 10/613; H01M 10/627; H01M 10/6563; H01M 2200/103; H01M 2220/10

(57) ABSTRACT

A double-walled battery charging cabinet can include: an outer cabinet wall; an inner cabinet wall spaced apart from the outer cabinet wall to form an insulating air gap between the inner cabinet wall and the outer cabinet wall, the inner cabinet wall defining an interior volume; and an air convection port disposed through the outer cabinet wall and the inner cabinet wall. The double-walled battery charging cabinet can further include: a flame arrestor positioned inside or adjacent to the air convection port; a damper positioned adjacent to the air convection port, the damper being biased toward a closed position; a fusible link to hold the damper in an open position, the fusible link having a predetermined melting point at which the damper is released to slide horizontally from the open position to the closed position; and a power outlet disposed inside the interior volume.

### RELATED APPLICATIONS

This claims priority to U.S. Provisional Application No. 63/467,712, filed on 19 May 2023, entitled “BATTERY CABINET,” the disclosure of which is expressly incorporated herein by reference in its entirety.

### FIELD

The described embodiments relate generally to battery cabinets (e.g., cabinets in which rechargeable batteries can be charged and stored).

### BACKGROUND

Many industries involve the use of devices and machinery that are battery operated. Such batteries typically include rechargeable batteries (e.g., lithium ion batteries). Unfortunately, the proliferation of battery powered devices (including automobiles, hand tools, drones, and personal mobility devices) has caused a rise in battery related fires-resulting in property damage and personal injury. However, there is no safety standard or code for handling the storage and charging of these batteries. Accordingly, there is a significant need for a battery cabinet that can safely charge and store rechargeable batteries, particularly in a setting where multiple battery packs-numbering from several battery packs to several dozen battery packs-need to be charged and stored.

To illustrate this need, rechargeable batteries undergo thermal changes while charging. Over time, these rechargeable batteries can undergo thermal failure (or thermal runaway) while charging. These thermal failures can lead to a build-up of gases inside the outer ABS plastic shell of a battery pack. The build-up of gases can culminate in unsafe battery termination (e.g., a fiery explosion of flames, hot gas, battery acid, and toxic fumes/smoke). In certain situations, a thermal failure and subsequent battery termination has the potential to cause a daisy-chain effect—where neighboring battery packs can similarly begin thermal failure and termination in response to rapid increases in cabinet temperature.

Conventional cabinets in the art are ill-suited and poorly designed to handle safe battery charging and storage. Specifically, many EN cabinets (e.g., under European safety standard EN 14470-1) are not designed for containment of thermal failure and battery termination. Instead, these types of cabinets are designed to protect the internal contents, such as flammable liquids, from external fire hazards. Thus, EN cabinets have fire-rated walls insulated with gypsum board-which lends to heavy, non-portable designs. In addition, to combat external fire hazards, temperature-triggered mechanisms for at least some EN cabinets are positioned externally or embedded within the insulated wall structure, but not inside an interior volume of the EN cabinet. Accordingly, EN cabinets do little to safely and adequately contain one or more batteries undergoing thermal failure and termination inside the EN cabinet. In addition, the lengthy fire ratings also lend to complex designs, which in turn requires labor intensive manufacturing, longer lead times, and higher costs.

As mentioned above, battery terminations can occur inside a cabinet during charging or storage. These battery terminations can be fast and ferocious (e.g., often as fast as a few seconds or a few minutes). As a result, the lengthy fire ratings and backwards design of EN cabinets protecting the inside of the cabinet from the ambient environment are poorly designed for safely charging and storing rechargeable batteries. Similarly, fire suppression methods of some EN cabinets do little to contain or prevent thermal failure and battery termination inside the cabinet because lithium ion batteries can sustain a burn with little or no external oxygen.

Other cabinets, including conventional FM rated cabinets, are also not equipped to safely handle the charging and storing of rechargeable batteries. For example, such cabinets do not have internal temperature-based mechanisms, ventilation, triggerable ventilation closing, etc. to help contain thermal failures and battery termination discussed above.

The subject matter claimed herein is not limited to embodiments that solve any disadvantages or that operate only in environments such as those described above. Rather, this background is only provided to illustrate one example technology area where some embodiments described herein may be practiced.

### SUMMARY

An aspect of the present disclosure relates to a doubled-walled battery charging cabinet. In some examples, the double-walled battery charging cabinet can include: an outer cabinet wall; an inner cabinet wall spaced apart from the outer cabinet wall to form an insulating air gap between the inner cabinet wall and the outer cabinet wall, the inner cabinet wall defining an interior volume; an air convection port disposed through the outer cabinet wall and the inner cabinet wall; a flame arrestor positioned inside or adjacent to the air convection port; a damper positioned adjacent to the air convection port, the damper being biased toward a closed position; a fusible link to hold the damper against the bias member and in an open position, the fusible link have a predetermined melting point that, when reached, releases the damper to slide horizontally from the open position to the closed position; and a power outlet disposed inside the interior volume.

In some examples, the double-walled battery charging cabinet can further include one or more spring members to bias the damper toward the closed position. In particular examples, the double-walled battery charging cabinet can further include a screen positioned adjacent to the air convection port, the screen including a cored-out region for air flow through the screen. In these or other examples, the screen defines a slotted portion, and the damper includes a bracket extending through the slotted portion to engage the fusible link. In at least one example, the double-walled battery charging cabinet further includes: a door and a corresponding door jamb enclosing the interior volume; and an intumescent seal disposed around at least one of the door or the door jamb. In some examples, the door includes a first vent, a second vent, and filter media disposed between the first vent and the second vent.

In one or more examples, the air convection port includes an air inlet, and the double-walled battery further includes an additional air convection port that includes an air outlet. In some implementations, the air convection port includes a fan. In certain examples, the double-walled battery charging cabinet further includes feet to support the double-walled battery charging cabinet on a surface.

Another aspect of the present disclosure relates to a battery charging cabinet. The battery charging cabinet can include: a reinforced wall defining an interior volume; a shelf disposed within the interior volume and dividing the interior volume into at least a first portion and a second portion; an air inlet disposed through the reinforced wall for airflow into the first portion at a first end of the battery charging cabinet; an air outlet disposed through the reinforced wall for airflow out of the second portion at a second end of the battery charging cabinet opposite the first end; and a spring-loaded damper positioned adjacent to each of the air inlet and the air outlet, the spring-loaded damper being slidable between open and closed positions.

In these or other examples, the reinforced wall includes a first wall layer and a second wall layer. In some examples, the battery charging cabinet further includes an air gap between the first wall layer and the second wall layer. In one or more examples, the battery charging cabinet further includes a fusible link to hold the spring-loaded damper in the open position when the fusible link is exposed to temperatures in the interior volume that are less than a predetermined temperature. The battery charging cabinet can further include a flame arrestor positioned inside or adjacent to at least the air inlet. In one example, the battery charging cabinet includes a power outlet disposed in at least one of the first portion or the second portion of the interior volume.

Another aspect of the present disclosure relates to a battery cabinet. The battery cabinet can include: an outer cabinet wall; an inner cabinet wall spaced apart from the outer cabinet wall to form an insulating air gap between the inner cabinet wall and the outer cabinet wall; a pair of doors, wherein the inner cabinet wall and the pair of doors enclose an interior volume within the battery cabinet; a pair of air convection ports disposed through the outer cabinet wall and the inner cabinet wall at opposing cabinet ends and at different heights within the interior volume, wherein at least one air convection port of the pair of air convection ports includes a fan; a flame arrestor positioned inside or adjacent to at least one air convection port of the pair of air convection ports; a horizontally-slidable damper positioned adjacent to each air convection port of the pair of air convection ports, the horizontally-slidable damper being biased toward a closed position; a fusible link to laterally hold the horizontally-slidable damper against the bias member and in an open position based on a temperature within the interior volume; and a power outlet disposed inside the interior volume.

In these or other examples, each door of the pair of doors can be double-walled. In some examples, each door of the pair of doors includes a flange. In particular examples, the battery cabinet further includes a shelf dividing the interior volume into at least a first portion and a second portion, wherein cross-ventilation occurs between the first portion and the second portion during operation of the pair of air convection ports. In a specific implementation, each door of the pair of doors includes: an inner door vent and an outer door vent, a first flame arrestor positioned adjacent to the inner door vent and a second flame arrestor positioned adjacent to the outer door vent; and mineral wool positioned between the first flame arrestor and the second flame arrestor.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1-3 respectively illustrate example environments of a battery cabinet in accordance with one or more examples of the present disclosure;

FIG. 4 illustrates a top-front perspective view of an example battery cabinet in accordance with one or more examples of the present disclosure;

FIG. 5 illustrates another top-front perspective view of an example battery cabinet in accordance with one or more examples of the present disclosure;

FIG. 6 illustrates a bottom-rear perspective view of an example battery cabinet in accordance with one or more examples of the present disclosure;

FIGS. 7-9 respectively illustrate different cross-sections of a battery cabinet in accordance with one or more examples of the present disclosure;

FIGS. 10-12C illustrate an example screen-damper assembly in accordance with one or more examples of the present disclosure;

FIG. 13 illustrates a close-up view of a portion of an example battery cabinet in accordance with one or more examples of the present disclosure; and

FIGS. 14A-14B respectively illustrate outside perspective and inside perspective cross-sectional views of example battery cabinet doors, in accordance with one or more examples of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a battery cabinet. The battery cabinet can include a power outlet positioned inside to charge multiple batteries (e.g., simultaneously). In addition, the battery cabinet can include one or more shelves for positioning the batteries on a charger or for storing batteries. The battery cabinet can include compartments or rows achieved by using the one or more shelves to divide the interior volume into various portions, as may be desired.

In one example, the battery cabinet can include an insulated or reinforced housing. In particular examples, the battery cabinet can include a double-walled housing (e.g., inner and outer cabinet walls separated by an air gap) with at least one door to enclose an interior volume. In these or other examples, the insulated (e.g., air-insulated) double-walled housing of the battery cabinet can help mitigate heat transfer from the interior volume to an ambient environment. Additionally, the doubled-walled structure can act as reinforcement to help contain explosive events within the interior volume. Selectively reinforced portions can also help prevent deformation of the battery cabinet during explosive events and help to safely route (and alleviate) internal pressure build-up through specially designed door vents.

Devoid of heavy insulation materials (e.g., gypsum board or plaster board), a battery cabinet of the present disclosure is thus comparatively lighter weight than conventional EN cabinets. Accordingly, a battery cabinet of the present disclosure can be more easily transported, moved, lifted, mounted, or stacked.

Additionally, in one or more examples, the battery cabinet can also include forced ventilation (including high-airflow and/or cross-airflow) for actively cooling the interior volume while batteries undergo charging. In the event of a thermal failure or a battery termination, a battery cabinet of the present disclosure includes various features to help contain these events to the interior volume. For example, a battery cabinet of the present disclosure can include a damper to seal off the ventilation ports for mitigating the escape of combustive energy and smoke/fumes (as well as halting airflow to feed any combustive energy in the interior volume). In particular examples, the damper is temperature-activated based on temperatures within the interior volume of the battery cabinet. For example, the damper can be activated via fusible links that can melt at a predetermined temperature. Further, in some embodiments, the damper can be actively biased to move to a closed position. For instance, the damper can be spring-loaded to ensure the damper closes at the appropriate time prior to or during a thermal event. This active biasing can overcome potential issues with gravity-based dampers (that may be prone to corrosion, blocking debris, or other inhibiting force that resists the damper's gravity fall to a closed position).

A battery cabinet of the present disclosure can also include one or more flame arrestors. For example, a flame arrestor can be positioned at one or both of an air inlet and an air outlet. The flame arrestors can mitigate or prevent a flame from escaping through the ventilation ports and out of the battery cabinet. Further, in some examples, a flame arrestor can provide additional or alternative flame protection for an ambient environment, even in the event a damper is not activated prior to an explosive event inside the interior volume. Flame arrestors and/or filter media can be positioned at door vents for similar purposes.

In at least some implementations, a battery cabinet of the present disclosure can include intumescent seals for mitigating the escape of flames and smoke. Additionally or alternatively, a battery cabinet of the present disclosure can include extended flanges, deflectors, etc. to lengthen the required travel for an escaping flame (thereby reducing or even entirely quashing the combustive energy from escaping the battery cabinet).

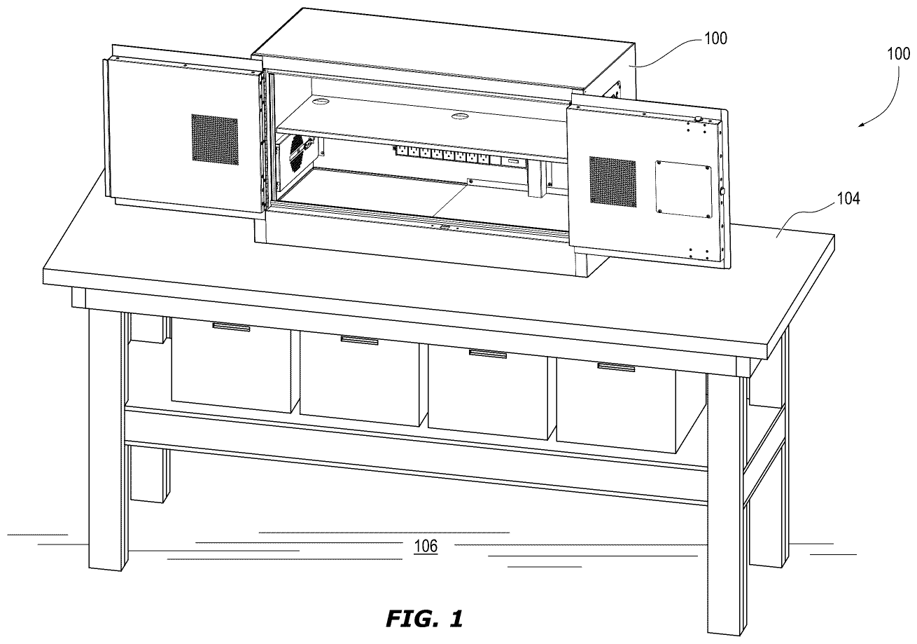

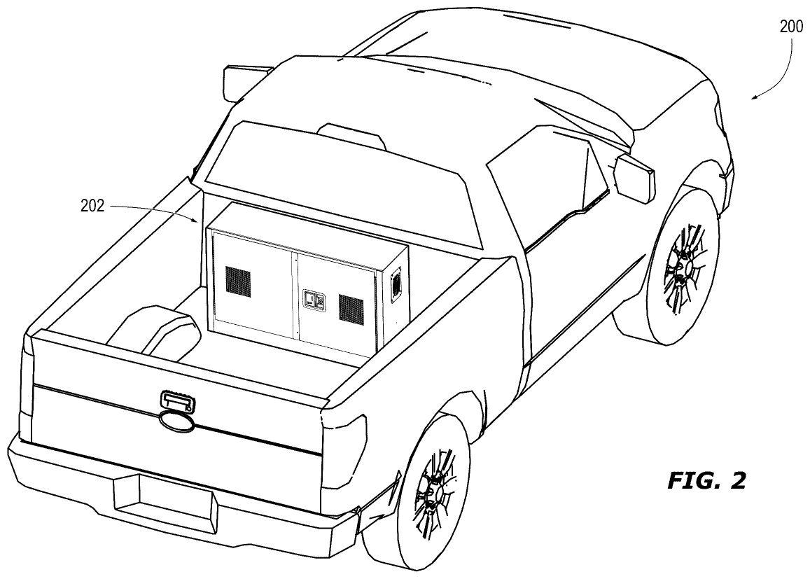

These and other embodiments are discussed below with reference to FIGS. 1-13. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1-3 respectively illustrate example schematic environments of a battery cabinet 102 in accordance with one or more examples of the present disclosure. While FIGS. 1-3 are more schematic in nature, subsequent figures describe the more particular features, components, and configurations of the battery cabinet 102.

In FIG. 1, an environment 100 depicts the battery cabinet 102 positioned on a workbench 104. The workbench 104 can include a horizontal surface above a ground surface 106. For instance, the workbench 104 can include a table, desk, platform, shelf, etc. It will also be appreciated that the workbench 104 need not contact the ground surface 106. For example, the workbench 104 can be cantilevered from a wall so as to be suspended above the ground surface 106.

Accordingly, the battery cabinet 102 can be sized and shaped to accommodate a myriad of different types of workbenches and spatial footprints. In some examples, the battery cabinet 102 is sized and shaped to accommodate different volumes of battery containment, such as between a 10 and 20 gallon volume containment, between a 30 and 50 gallon volume containment, or between a 50 and 75 gallon volume containment.

Likewise, the battery cabinet 102 can include a weight that allows users to easily maneuver the battery cabinet 102 on or off the workbench 104, up flights of stairs, etc. Indeed, as will be described below, the battery cabinet 102 can include various lightweight design features, including an insulating air gap devoid of heavy insulation materials (like gypsum board, which is common in EN style cabinets). In particular examples, the battery cabinet 102 ranges from about 140 pounds to 350 pounds, depending on the volume size of containment. In at least one example, the battery cabinet 102 is about 150 pounds to about 175 pounds (e.g., for a 17-gallon volume containment size). Such a weight of the battery cabinet 102 can add tremendous portability to the battery cabinet 102, particularly in view of similar sized conventional EN style cabinets being about 25% to about 60% heavier.

FIG. 2 illustrates an environment 200 in which the battery cabinet 102 is positioned on or within a vehicle 202. In particular examples, (and as shown), the battery cabinet 102 is positioned in the bed of the vehicle 202. A variety of mounting positions within the vehicle 202 are herein contemplated. For example, the battery cabinet 102 can be mounted to a floor surface of the vehicle bed (e.g., adjacent to the rear cab window, adjacent to the wheel wheels, adjacent to the tailgate, etc.). Additionally or alternatively, the battery cabinet 102 can be mounted to (or supported by) the walls of the vehicle bed. For instance, the battery cabinet 102 can be mounted on the bed rails extending between the rear cab window and the tail gate. In these or other examples, the battery cabinet 102 can be compatible with covered vehicle beds (e.g., with an enclosed shell disposed over the vehicle bed). Still, in other examples, the battery cabinet 102 can be mounted or positioned inside the cab (i.e., not in the vehicle bed). The vehicle 202 can correspond to a variety of different vehicles, including landscaping vehicles, emergency vehicles (e.g., ambulances, firetrucks, police vehicles), utility trucks, motorhomes, etc. Alternatively to an actual vehicle, it will be appreciated that the vehicle 202 can include trailers (e.g., utility trailers, welding trailers, etc.), campers (RV's), and the like.

In these or other examples, the battery cabinet 102 can be mounted with fasteners, interlocking members, fitted recesses or receptacles, etc. In other examples, the battery cabinet 102 can be placed on a surface (e.g., in a truck bed, similar to a tool box). Thus, in some examples, the battery cabinet 102 may include weather-resistant features to operate (and prevent damage) despite exposure to the natural elements, such as rain, snow, or cold/hot temperatures. Examples of such features may include gaskets, sealants, coatings, covers, shells, shields, thermal blankets, thermal reflectors, etc. Alternatively, the battery cabinet 102 may be protected or at least partially encased by the vehicle 202 (e.g., under the side panel of a firetruck).

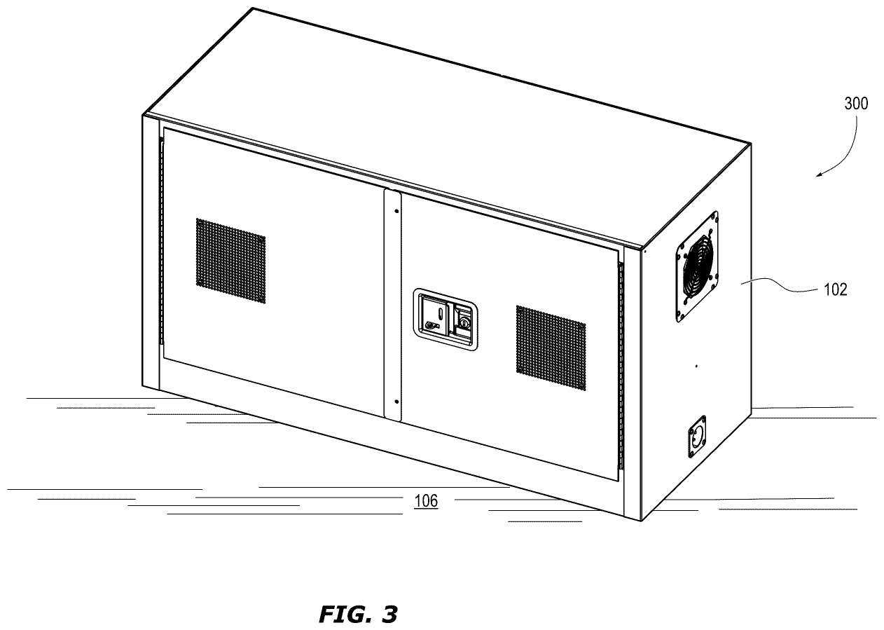

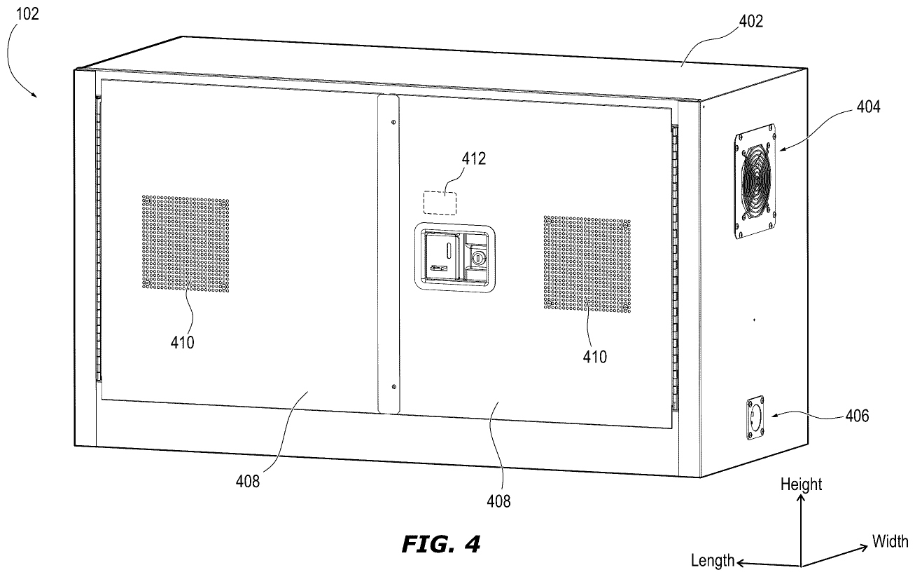

FIG. 3 illustrates another example environment 300 in which the battery cabinet 102 is positioned on the ground surface 106 (e.g., without any intermediate support structure). In this example, the battery cabinet 102 comprises a standalone or self-standing cabinet. Although not schematically shown, it will be appreciated that the battery cabinet 102 may include rollers (e.g., caster wheels), support feet (e.g., mounting feet), legs (e.g., leveling legs), or other elements to support the battery cabinet 102 on the ground surface 106 (or a vehicle surface).

Additionally, although these and other implementations described herein pictorially reference horizontal embodiments (e.g., with greater length than height), alternative embodiments of the battery cabinet 102 can be more vertical (e.g., with greater height than length). Such implementations may be particularly viable, for instance, in the environment 300 where the battery cabinet 102 rests on the ground surface 106 (as opposed to a workbench surface or a vehicle surface).

Further, in one or more of the foregoing environments, the battery cabinet 102 can be stacked atop each other or mounted to one another. In certain examples, one or more of the battery cabinet 102 in a stacked configuration can also be implemented with anchors (e.g., fasteners) to hold the battery cabinet 102 against a wall or support structure when in a stacked configuration.

Modifications to the foregoing environments also fall within the scope of the present disclosure. Indeed, any of the environments 100-300 can be implemented in a network environment. For example, in some embodiments, the battery cabinet 102 can communicate with one or more client devices via a network (e.g., to alert users, trigger a building alarm, activate emergency safety measures, flash a visual warning indicator, sound an audible siren, engage a damper of the battery cabinet 102, cut power from the power supply to the battery cabinet 102, send an SMS message, etc.). Similarly, one or more sensors (e.g., temperature sensors, sound sensors, pressure sensors, smoke/gas sensors, light sensors, door ajar sensors, etc.) can be implemented within the battery cabinet 102 to communicate data to one or more client devices via the network. In such cases, the one or more sensors can be implemented for real-time detection and/or in conjunction with a variety of Internet-of-Things arrangements and accessory device configurations.

In such an example, a client device can include variety of computing devices. Some examples of computing devices include a smartphone, tablet, smart television, desktop computer, laptop computer, virtual reality device, augmented reality device, or other computing device. Other types of computing devices include a content server, data collection server, application server, communication server, third-party server, etc.

Regarding a network to facilitate such communication between the battery cabinet 102 and a client device, the network can also include a myriad of different types of networks (whether wired or wireless networks for communication). For instance, one or more of the components in the environments 100-300 can communicate via a wireless local area network communication, wireless area network communication, wireless personal area network communication, wide area network communication, etc. Some particular examples of wireless communication include a Wi-Fi based communication, cellular-based network communication, satellite communication, mesh network communication, BlueTooth® communication, near-field communication, low-energy communication, Zigbee® communication, Z-wave communication, 6LoWPAN communication, radio frequency communication, etc. Other forms of network communication are based on wired connections, such as an Ethernet connection, USB connection, UART connection, USART connection, I2C connection, SPI connection, QSPI connection, etc.

Any of the features, components, and/or parts, including the arrangements and configurations thereof shown in FIGS. 1-3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1-3.

FIG. 4 illustrates a top-front perspective view of an example battery cabinet in accordance with one or more examples of the present disclosure. In particular, FIG. 4 illustrates the charging cabinet 102 comprising reinforced walls 402. The reinforced walls 402 can be reinforced in various ways (e.g., for increased rigidity, strength, thermal properties, etc.). In particular, the reinforced walls 402 can withstand (and contain) thermal failures of one or more batteries, including explosive blasts and fire-blaze temperatures. To do so, the reinforced walls 402 can include a metal material, a rigid material, a fire-resistant material, etc. In some examples, the reinforced walls 402 comprises a thickness (or gauge) between 1 hundredth of an inch (0.01″) steel to ⅛ inch steel (e.g., for one or more metal layers). In at least one example, the reinforced walls 402 comprise one or more steel layers of about 0.0425 inch thickness or 18-gauge steel. In specific implementations (discussed below), the reinforced walls 402 comprises multiple wall layers (e.g., an inner cabinet wall and an outer cabinet wall) separated by an insulating air gap.

Additionally shown, the battery cabinet 102 can include an air convection port 404 through the reinforced walls 402 and into the interior volume of the battery cabinet 102. The air convection port 404 can include an air inlet and/or an air outlet. The air convection port 404 can be uni-directional (e.g., exclusively an inlet or exclusively an outlet). Alternatively, the air convection port 404 can be bi-directional (e.g., as both an inlet and outlet). In some examples, the air convection port 404 can include a fan, blower, pump, etc. to force ventilation through the battery cabinet 102. In this manner, the air convection port 404 can actively cool the interior volume of the battery cabinet 102 by bringing in cool air from the ambient environment (or other air source, such as a chiller or pneumatic pump). Additionally or alternatively, the air convection port 404 can actively cool the interior volume of the battery cabinet 102 by taking out hot air from inside the interior volume of the battery cabinet 102.

Although not expressly shown in the figures, it will be appreciated that the air convection port 404 can be modified in various ways. For example, the air convection port 404 can include a raised collar. The raised collar can facilitate ducting, fittings, etc. for actively extracting (e.g., vacuum suctioning) out air from the interior volume 500.

It will be appreciated that the air convection port 404 can operate on a continual basis (e.g., when powered). In other examples, the air convection port 404 can operate in certain time intervals or based on a temperature of the interior volume. In at least one example, the air convection port 404 can operatively halt during a thermal event from thermal failure or catastrophic termination of a battery inside the interior volume.

The battery cabinet 102 can also include an electrical port 406. The electrical port 406 can be electrically connected to other components of the battery cabinet 102 (such as the power outlet 518, the air convection port 404, etc.). In these or other examples, the electrical port 406 can include a male or female connector for at least one of a 110V, a 120V, a 220V, or a 240V connection with a power supply. In specific implementations, the electrical port 406 can provide 120 VAC, 60 Hz power to the battery cabinet 102 from a power supply. In other implementations, the electrical port 406 can provide 240 VAC, 50 Hz power to the battery cabinet 102 from a power supply. In one or more examples, the electrical port 406 and/or associated power cabling can include various power routing implements, such as a splitter, adapter, converter, stepper, etc. to route power to various components of the battery cabinet 102.

As used herein, the term “power supply” refers to any power source that supplies power to the battery cabinet 102. For example, a power supply can include fuel cells, battery cells, generators, alternators, solar power converters, motion-based converters (e.g., that convert vibrations or oscillations into power), etc. In particular implementations, a power supply can convert alternating current to direct current (or vice-versa) for powering or charging/recharging components of the battery cabinet 102. Some particular examples of a power supply can include a switched mode power supply, an uninterruptible power supply, an alternating current power supply, a direct current power supply, a regulated power supply, a programmable power supply, a computer power supply, and a linear power supply. In some examples, a power supply includes a vehicle power supply, such as a vehicle battery.

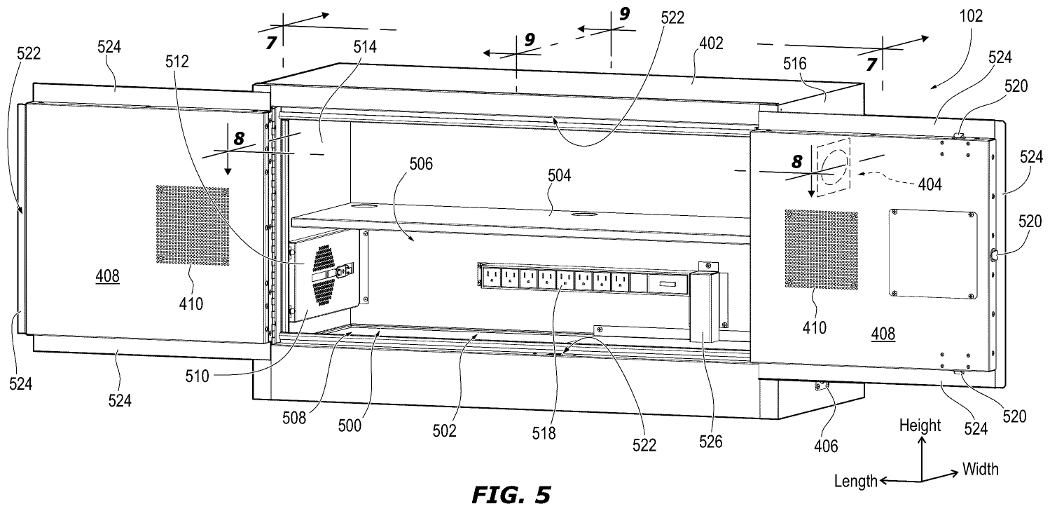

The battery cabinet 102 can further include one or more doors 408. As shown, the battery cabinet 102 can include two doors 408. The doors 408 (as depicted in FIG. 5) can laterally swing out to expose the interior volume of the battery cabinet 102. However, in other examples, the doors 408 can open vertically, roll up, slide, etc. In particular implementations, the doors 408 can auto-close or self-close (e.g., in the absence of an external force holding the doors 408 ajar). In particular examples, however, the doors 408 can be manually opened and/or closed. Additionally, in some examples, the doors 408 can lock. Further, in certain examples, the doors 408 can include a same or similar construction as the reinforced walls 402 (e.g., double walls). In at least one example, the doors 408 can include specialized hinges with flame guards (not shown) to mitigate or prevent flames from escaping through the door hinges.

In particular examples, the doors 408 can include vents 410. The vents 410 can include at least one aperture defined by the outer surface of the door 408 and at least one aperture defined the inner surface of the door 408, thereby fluidly connecting the interior volume of the battery cabinet 102 and the outside ambient environment. In certain implementations, the vents 410 include a plurality of apertures defined by both the outer surface and the inner surface of the doors 408. In specific examples, the vents 410 do not enable free exchange of air between the interior volume of the battery cabinet 102 and the outside ambient environment. The vents 410, for example, can include a flame arrestor and/or one or more filter media that limits, filters, and/or or controls fluid (e.g., air) exchange through the vents 410. In this manner, the vents 410 can enable decompression of the interior volume of the battery cabinet 102 by allowing air to be pushed (e.g., outward into the ambient environment) through the vents 410, thereby controlling or limiting the build-up of pressure inside the interior volume of the battery cabinet 102. In some examples, by reducing or eliminating trapped gasses inside the battery cabinet 102 (as may occur during a thermal runaway event), re-ignition of one or more battery elements inside the battery cabinet 102 can be mitigated or entirely prevented. Additionally, the vents 410 can serve as explosion relief in which a percussive blast inside the interior volume of the battery cabinet 102 is safely attenuated when routed through the vents 410 (as opposed to forcing unintended explosion release pathways around or through various structures of the doors 408). Additional detail of the vents 410 is provided below in relation to FIGS. 15A-15B.

In at least one example, the doors 408 can include a temperature indicator 412. The temperature indicator 412 can include a visual marker (e.g., a sticker, surface thermometer, etc.) that indicates whether the surface temperature of the battery cabinet 102 has reached a threshold temperature (e.g., about 120 degrees fahrenheit or other suitable temperature threshold indicative of a thermal runaway event inside the battery cabinet 102). For example, the temperature indicator 412 can change color to a warning color (e.g., black, red, orange, etc.) when the surface temperature of the battery cabinet 102 has reached a threshold temperature. In these or other examples, the temperature indicator 412 can be positioned in close proximity to the door handle for convenient visual aid to users who may wish to open or touch the battery cabinet 102.

FIG. 4 further shows indicators for the cross-sectional views of FIGS. 7-9. These figures depict certain components inside the interior volume and/or the structure of the reinforced walls 402, the electrical port 406, and the doors 408 introduced in this figure.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 illustrates another top-front perspective view of the battery cabinet 102 in accordance with one or more examples of the present disclosure. In particular, FIG. 5 depicts the battery cabinet 102 with the doors 408 opened to expose an interior volume 500. In these or other examples, the metes and bounds of the interior volume 500 are bounded by the reinforced walls 402 and the doors 408. As shown, the interior volume 500 comprises a bottom shelf 502 and a top shelf 504. The top shelf 504 divides the interior volume 500 into an upper portion 506 and a lower portion 508. In alternative embodiments, more or fewer shelves may be implemented. Likewise, different partitions and compartments can be formed than illustrated.

In some examples, the bottom portion 508 is for charging batteries, and the upper portion 506 is for storing batteries that are not in a charging cycle (e.g., fully charged batteries, used batteries, or dead batteries ready to be charged). In this example configuration, the charging batteries can be cooled with direct air application from an air convection port 510 (e.g., an air inlet). The warmer air from the charging batteries in the lower portion 506 can then rise up and away from the charging batteries (e.g., naturally due to fluid buoyancy and/or aided by the air convection port 404). In particular, the warmer air from the charging batteries in the lower portion 506 can rise up to the upper portion 508 where the air convection port 404 can expel the warmer air. Alternatively, an opposite storage configuration may be maintained. Similarly, in some embodiments, an opposite air flow configuration may be implemented—where the air convection port 404 is an air inlet and the air convection port 510 is an air outlet. Regardless, by keeping charging batteries and non-charging batteries in separate areas of the interior volume 500, the battery cabinet 102 can decrease fire hazards within the battery cabinet 102. In other examples, both the upper portion 506 and the bottom portion 508 can both be used as charging compartments, or both as storing (non-charging) compartments. However, the battery cabinet 102 is not so limited. Indeed, charging batteries and non-charging batteries can be stored together in some examples.

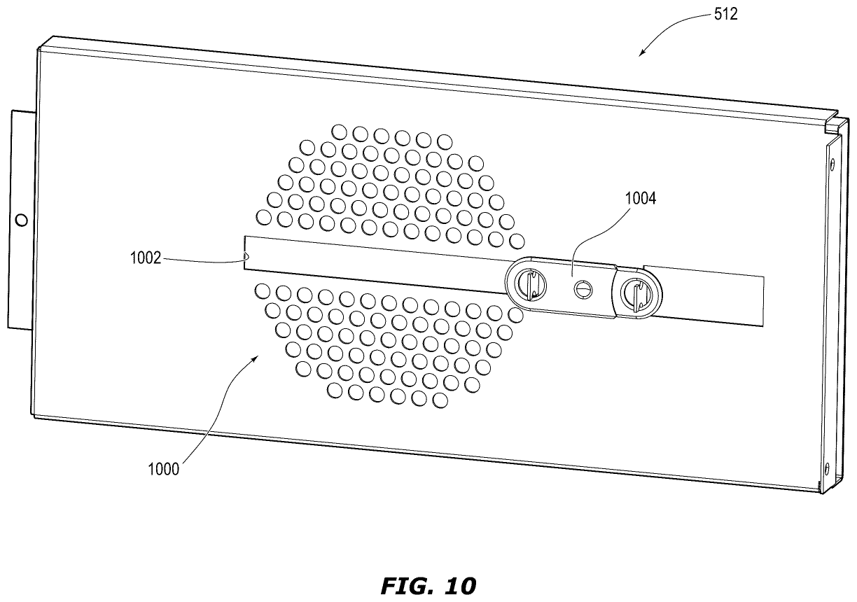

Further shown in FIG. 5, the air convection port 510 comprises a screen 512 (as does the air convection port 404, albeit not seen from this view). The screen 512 can include one or more elements to help maintain the air convection ports 404, 510 free and clear from blockage, debris, or the incidental intrusion of a user's arms or hands. In some examples, the screen 512 can include a guard, grate, grill, cover, etc. Additionally, and as will be described below in relation to FIGS. 10-12, the screen 512 can work in tandem with a damper to block off (e.g., seal, close shut, or inhibit) air flow through the air convection ports 404, 510.

In these or other examples, the air convection ports 404, 510 can be respectively positioned at opposite ends of the battery cabinet 102. Specifically, the air convection port 510 can be positioned at a first end 514 of the battery cabinet 102, and the air convection port 404 can be positioned at a second end 516 of the battery cabinet 102 opposite the first end 514. Additionally, and as shown, the air convection ports 404, 510 can be positioned in different compartments or at different heights (e.g., to achieve a cooler cross-ventilation along the upper portion 506 and a more targeted exhaust of warmer air in the lower portion 508 as discussed above). In alternative examples, however, the air convection ports 404, 510 can be positioned in a same portion of the interior volume 500 (e.g., both in the upper portion 506 or both in the lower portion 508). It will be appreciated that differing storage implementations may warrant these or other air flow configurations. Thus, the battery cabinet 102 may be configured in a myriad of different ways for both battery charging/storage and air flow.

Further shown in FIG. 5, the battery cabinet 102 can include a power outlet 518. In some examples, the power outlet 518 is electrically connected to the electrical port 406. Thus, the power outlet 518 can provide power to battery chargers, battery mounts, internal cabinet lights, etc. within the interior volume 500. Additionally or alternatively, the power outlet 518 can provide power to built-in components of the battery cabinet 102, such as the fan of the air convection port 404. In these or other examples, the power outlet 518 can include an outlet, socket, or power strip. In some examples, the power outlet 518 includes additional features (e.g., grounding, shielding, miniature circuit breaker, surge protection, timers, automatic power-off triggers, etc.). In particular implementations, the power outlet 518 can be programmed to shut off (e.g., during a thermal failure of a battery).

In one or more examples, the power outlet 518 can be positioned in various locations within the interior volume 500. As shown, the power outlet 518 is positioned on the back interior wall above the bottom shelf 502. However, the battery cabinet 102 is not so limited. Indeed, the power outlet 518 can additionally or alternatively be positioned directly on the top shelf 504 or the bottom shelf 502. In other examples, the power outlet 518 can be positioned vertically along one or more interior sidewalls of the battery cabinet 102 (such as on the back wall above the top shelf 504 and/or on an interior side wall). In specific implementations, the battery cabinet 102 includes multiple power outlets (e.g., one for the upper portion 506 and another one for the lower portion 508).

In one or more examples, cabling is provided to the power outlet 518 via access panel 526. The access panel 526 can prevent cabling (e.g., wires, cords, etc.) from being exposed to the interior volume 500. Specifically, cabling (not shown) can run from the electrical port 406, through the wiring space 706 (positioned below the interior volume 500), directly into a protected space defined by the access panel 526 (thereby bypassing the interior volume 500), and into the housing of the power outlet 518. In these or other examples, reducing or eliminating cabling exposure to the interior volume 500 can mitigate (or prevent) melting or degradation of wire insulation of the power cabling.

In certain examples, the doors 408 can also include reinforced portions. In particular examples, reinforced portions of the doors 408 can help direct percussion blasts that may occur inside the battery cabinet 102 to proceed through the vents 410 (rather than allowing explosion relief at unintended areas of the doors 408). To illustrate, the doors 408 can include reinforced latches (e.g., bolt latches 520 and/or latch plates 522 defining a latch aperture for receiving the bolt latches 520). In these or other examples, reinforced latch plates for the latch plates 522 can help ensure that the doors 408 remain shut, particularly during a percussion event when the bolt latches 520 impact the latch plates 522. As another example, the doors 408 can include reinforced door panels, particularly reinforced flanges 524 around the perimeter of the doors 408 and/or flange areas around the latches. The reinforced portions can be resistant to deformation, blast forces, etc. Reinforced portions can include increased material thickness, treated areas (e.g., heat treated or hardened portions), add-on sections, or multiple sheets or layers of material (e.g., stacked metal sheets), etc.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

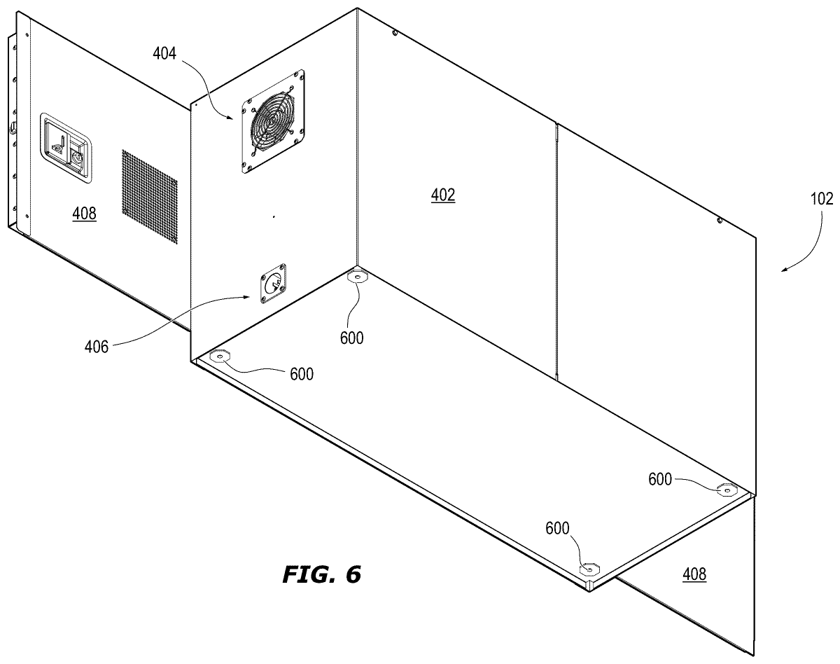

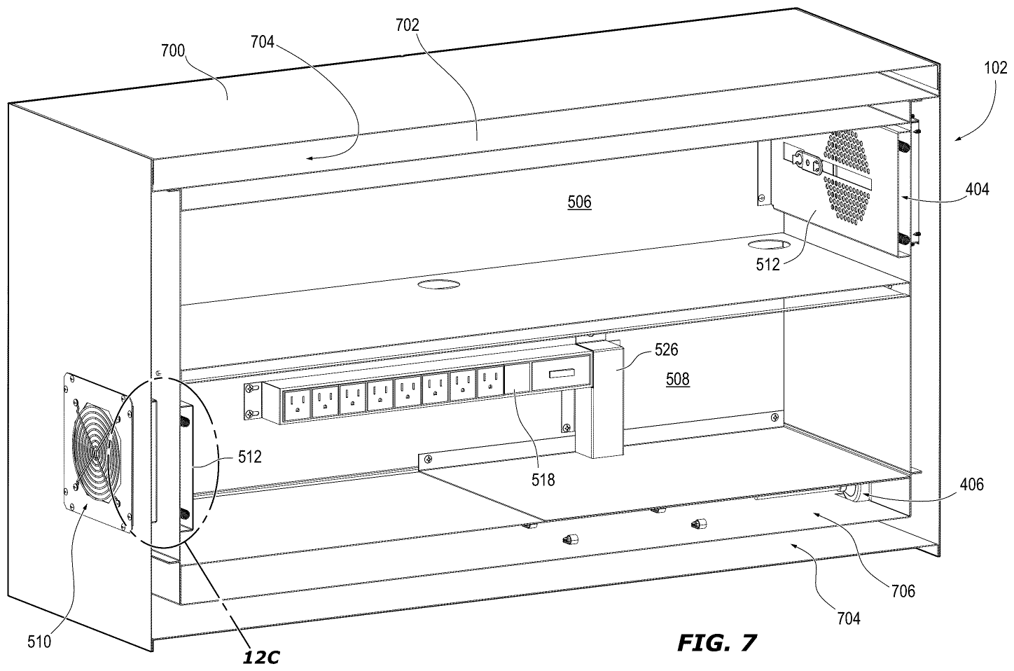

FIG. 6 illustrates a bottom-rear perspective view of the battery cabinet 102 in accordance with one or more examples of the present disclosure. In this view, a backside of the battery cabinet 102 is shown opposite the doors 408.

Further, FIG. 6 depicts a view of the air convection port 510; whereas the air convection port 510 was occluded from view in FIG. 5 by the screen 512. As mentioned above, the air convection port 510 can be an air inlet or an air outlet. In particular implementations, the air convection port 510 comprises a threaded inner surface to engage a pneumatic fitting that provides cool air (or ambient air) into the interior volume 500. Alternatively, in some embodiments, the threaded inner surface of the air convection port 510 can engage a vacuum fitting for sucking out air from the interior volume 500.

Additionally shown in FIG. 6, the battery cabinet 102 can include feet 600. In some examples, the feet 600 include adjustable feet (e.g., by threading the feet into or out of the battery cabinet 102 to correspondingly raise or lower the foot). In certain examples, the feet 600 are stationary feet (e.g., with a flattened contact surface to engage a ground surface, vehicle surface, benchtop surface, etc.). The feet 600 may include a friction-inducing material (e.g., rubber) to mitigate sliding or creep of the battery cabinet 102 on a surface. In at least some examples, the feet 600 can be secured or mounted (e.g., fastened) to a surface.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

FIGS. 7-9 respectively illustrate different cross-sections of the battery cabinet 102 in accordance with one or more examples of the present disclosure. The views of these figures are taken at cross-sections indicated in FIG. 4.

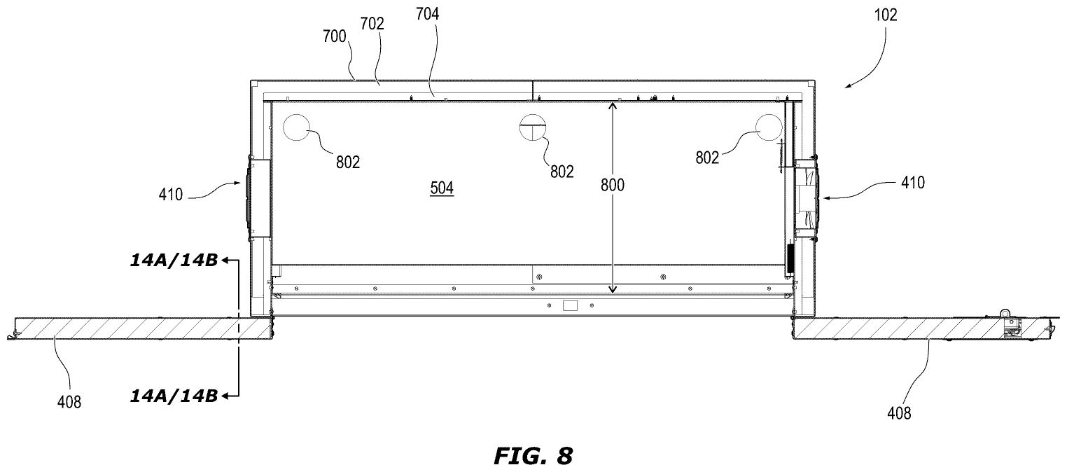

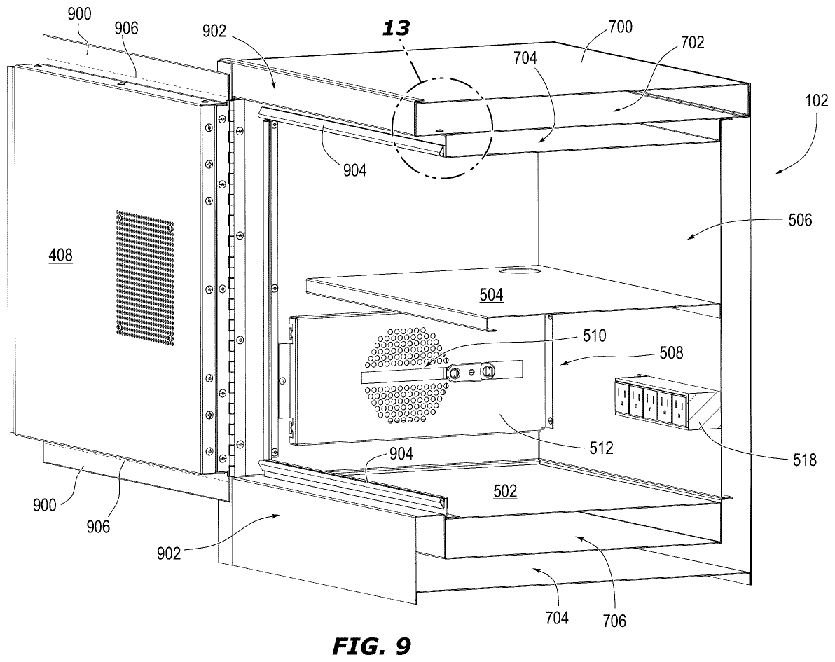

FIGS. 7-9 in particular illustrate an example wall construction of the battery cabinet 102. As shown, the battery cabinet 102 includes an outer cabinet wall 700 and an inner cabinet wall 702. The outer cabinet wall 700 and the inner cabinet wall 702 are spaced apart to form an insulating air gap (or air gap 704). In these or other examples, the air gap 704 is insulating due to its dimensional span between the outer cabinet wall 700 and the inner cabinet wall 702. The more distance between the outer cabinet wall 700 and the inner cabinet wall 702 equates to greater amounts of insulation (and vice-versa). That is, the more volume of air that is present between the outer cabinet wall 700 and the inner cabinet wall 702, the less heat transfer occurs inside-out from the inner cabinet wall 702 to the outer cabinet wall 700. In a same or similar manner, the doors 408 can include a double-walled construction (as shown in FIG. 8) with an air gap. In these or other examples, the air gap 704 ranges from a ½ inch span to a 5 inch span between the outer cabinet wall 700 and the inner cabinet wall 702. In particular implementations, the air gap 704 spans between 1 inch and 2 inches.

As mentioned previously, the battery cabinet 102 is devoid of heavy insulation materials typical of conventional EN style cabinets. Indeed, in particular examples, the air gap 704 is entirely devoid of any insulation material (apart from the present air particles and cabinet components disposed in the air gap). However, in some embodiments, the battery cabinet 102 can include a lightweight insulation material (i.e., lighter than gypsum board). For example, the air gap 704 can include mineral wool, spray foam, aerogel, polystyrene, polyurethane, fiberglass, cellulose insulation, polar fleece, etc. In at least some examples, a lightweight insulation material in the air gap 704 can mitigate heat transfer from the interior volume 500 to the outer cabinet wall 700.

In addition to an air gap, the battery cabinet 102 can also include a wiring space 706. The wiring space 706 may be sized and shaped to accommodate electrical wiring between the electrical port 406 and the power outlet 518. It will be appreciated, however, that the wiring space 706 may be omitted—in which case electrical wiring may run in the air gap 704 below the power outlet 518.

As just mentioned, certain cabinet components may be positioned within the air gap 704. One example includes door pistons (not shown). The door pistons can allow the doors 408 to open and close. In particular, the door pistons can provide a return bias for the doors 408 such that the doors 408 are self-closing.

Shown in at least FIG. 7, the battery cabinet 102 can include a flame arrestor 710. The flame arrestor 710 can be positioned inside (or adjacent to) one or both of the air convection ports 404, 510. As depicted in FIG. 7, the flame arrestor 710 is positioned inside the air convection port 510 between the outer cabinet wall 700 and the inner cabinet wall 702. In these or other examples, the flame arrestor 710 includes an inhibiting element that reduces or prevents the escape of flames. The flame arrestor 710 can be sufficiently dense to inhibit or prevent such flames, yet porous enough to allow air flow. In some examples, the flame arrestor 710 includes a stainless steel mesh plate, cover, or fitting. Other types of flame arrestors are herein contemplated.

In FIG. 8, the top shelf 504 is depicted as including a width 800. It will be appreciated that the width 800 can be tuned for cross-ventilation or airflow between the upper portion 506 and the lower portion 508. For example, the width 800 can be reduced to leave an interior gap between the doors 408 (when closed) and the top shelf 504. With such a gap, increased air flow can occur between the upper portion 506 and the lower portion 508. In other examples, the width 800 can extend as presently shown in which the top shelf 504 can contact or be positioned adjacent to the doors 408 when closed. Notwithstanding a closer fit, the top shelf 504 and corresponding width 800 as presently shown can allow for sufficient ventilation and airflow. Additionally, in some examples, the closer fit between the top shelf 504 and the doors 408 may be desired (e.g., for better separation between the upper portion 506 and the lower portion 508, such as for separate charging and non-charging battery compartments).

In some examples, the top shelf 504 can also include apertures 802. The apertures 802 can be sized and shaped to accommodate wiring (e.g., for electrical cords of charger bases positioned in the upper portion 506 to run to the power outlet 518 in the lower portion 508). Additionally or alternatively, the apertures 802 can accommodate airflow between the upper portion 506 and the lower portion 508 of the interior volume 500.

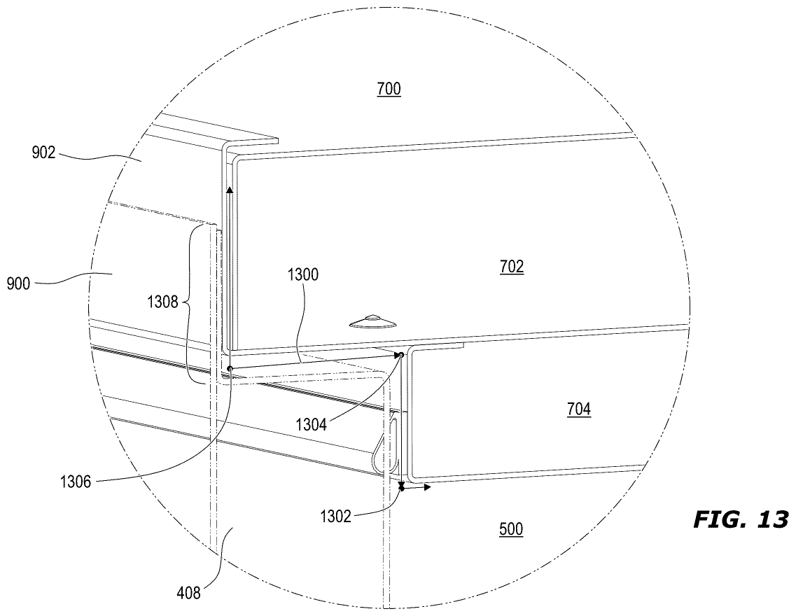

In FIG. 9, the door 408 is shown with a flange 900, which can be the same as or similar to the reinforced flanges 524 discussed above). The flange 900 can include an extension of the door 408 that extends along (or beyond) a door jamb 902 of the battery cabinet 102. For example, the flange 900 can include a lip or flap that covers the door jamb 902 and extends toward the top and bottom portions of the battery cabinet 102 (e.g., in a manner parallel to the doors 408). In these or other examples, the door jamb 902 refers to a door frame area of the battery cabinet 102 that engages or is positionable adjacent to the doors 408 when closed. As will be discussed more in FIG. 13, the flange 900 can lengthen the required travel for an escaping flame (thereby reducing or even entirely quashing the combustive energy from escaping the battery cabinet 102).

Further, the battery cabinet 102 can include deflectors 904 positioned on one or both of the shelves 502, 504. Like the flange 900, the deflectors 904 can similarly include a lip or flap. The deflectors 904 can contact or be positioned adjacent to the doors 408 when closed. In these or other examples, the deflectors 904 can deflect (e.g., block, reduce, or throttle) flames or explosive energy from escaping upwards or downwards along the doors 408.

Additionally, in some examples, the battery cabinet 102 can include intumescent seals 906. The intumescent seals can be disposed around at least one of the doors 408 or the door jamb 902. In some examples, intumescent seals include fire-resistant material(s). Additionally, the intumescent seals 906 can expand in the presence of elevated temperatures (e.g., to entirely or partially seal smoke and flames inside the interior volume 500).

Any of the features, components, and/or parts, including the arrangements and configurations thereof shown in FIGS. 7-9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7-9.

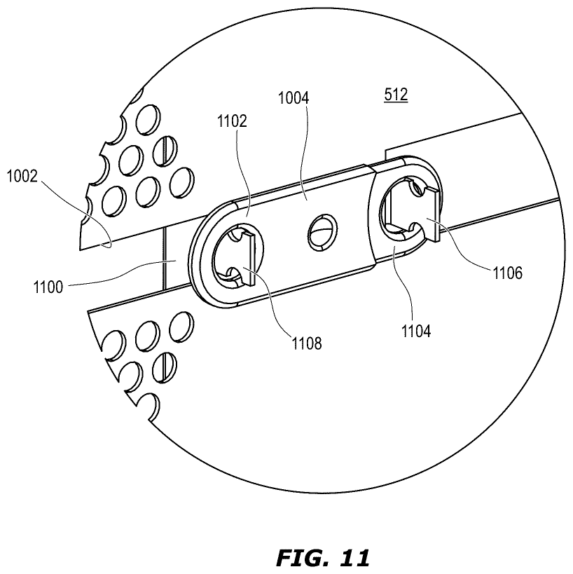

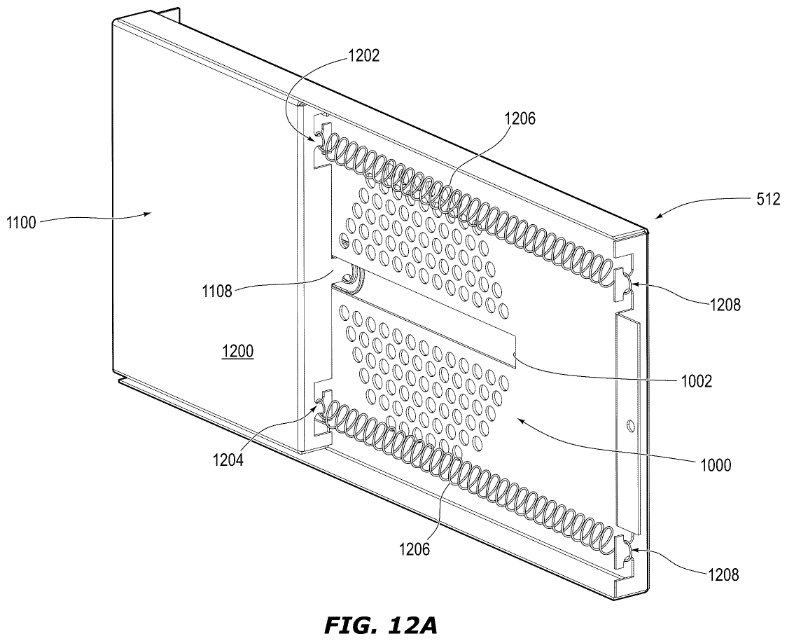

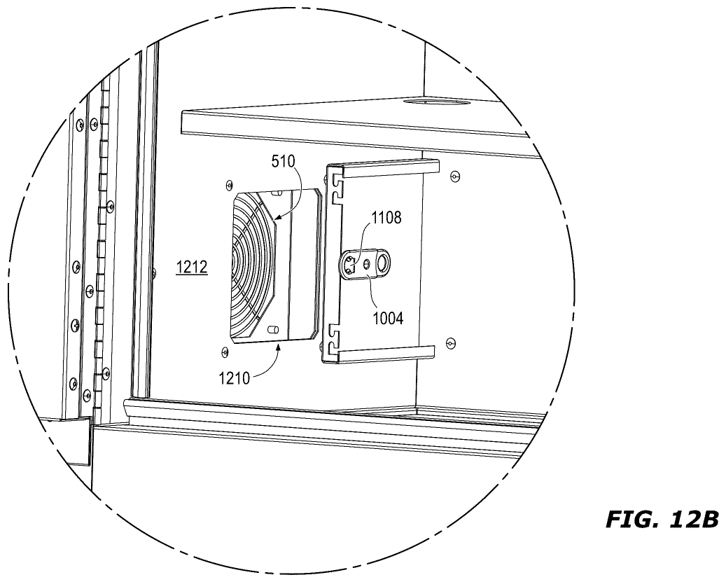

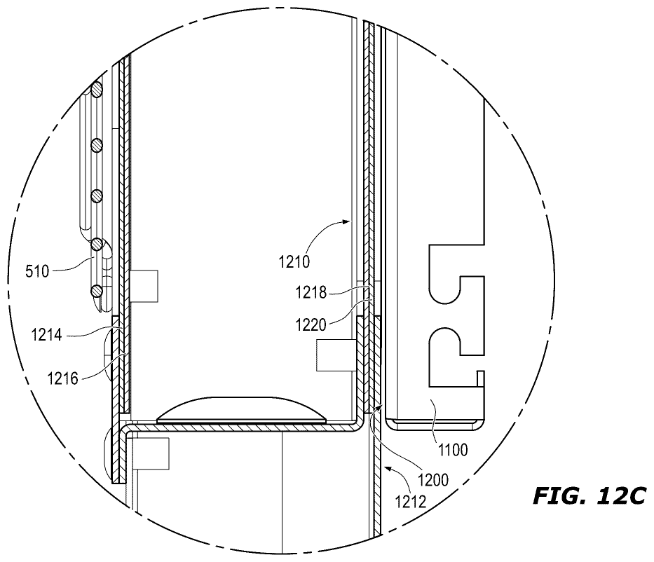

FIGS. 10-12A illustrate an example screen-damper assembly. In particular, FIGS. 10-12A illustrate the screen 512 in accordance with one or more embodiments of the present disclosure. Additionally, and as will be described more in relation to FIGS. 11-12C, the screen 512 includes a damper 1100 for closing off an air convection port.

As shown in FIG. 10, the screen 512 includes a cored-out region 1000. The cored-out region 1000 includes air holes for allowing air flow through the screen 512. In particular, the cored-out region 1000 includes a hexagonal-shaped configuration of holes. However, it will be appreciated that the cored-out region 1000 can include a myriad of different holed configurations (e.g., circular shaped configurations, triangular shaped configurations, square shaped configurations, polygonal shaped configurations, etc.). In at least some examples, different-shaped configurations of the cored-out region 1000 can provide different air flow properties (as can hole size and spacing).

Further shown in FIG. 10, the screen 512 can include a slotted portion 1002. The slotted portion 1002 includes a cutout within the screen 512 through which a damper bracket (i.e., the damper bracket 1108 shown in FIGS. 11-12C) can slide when the damper opens and closes.

A fusible link 1004 can be implemented to maintain the damper 1100 in an open position. As used herein, the term “fusible link” refers to a meltable element that can melt at a predetermined temperature (e.g., a melting point or a pre-identified/certified temperature at which the fusible link will at least begin to flow in a fluid or semi-fluid form). Examples of a predetermined temperature range from about 100 degrees fahrenheit to about 250 degrees fahrenheit, about 125 degrees fahrenheit to about 150 degrees fahrenheit, or about 130 degrees Fahrenheit to about 170 degrees fahrenheit. In specific implementations, the predetermined temperature is about 135 degrees fahrenheit. When the fusible link 1004 is exposed to the predetermined temperature, the fusible link 1004 can release the damper 1100 to a closed position (or more specifically, release the damper bracket 1108 as shown in FIG. 11).

In FIG. 11, the fusible link 1004 includes a first portion 1102 connected to the damper bracket 1108. In addition, the fusible link 1004 can include a second portion 1104 connected to a screen bracket 1106. Together, the first portion 1102 and the second portion 1104 can anchor the damper 1100 in place until the fusible link 1004 is exposed to a temperature within the interior volume 500 that meets or exceeds the predetermined temperature. Thus, when the fusible link 1004 is exposed to the predetermined temperature, at least one of the first portion 1102 releases the damper bracket 1108 or the second portion 1104 releases the screen bracket 1106. Upon release, the damper bracket 1108 can slide through the slotted portion 1002 as the damper 1100 closes shut (thereby sealing off airflow through the cored-out region 1000.

In these or other examples, a variety of fusible links may be implemented for the fusible link 1004. In some examples, the fusible link 1004 can include two strips of metal soldered together with a fusible alloy (e.g., a metal strip for the first portion 1102 and a metal strip for the second portion 1104 joined together by a soldered portion of a fusible alloy). At the predetermined temperature, the fusible alloy can melt and allow the two strips of metal to separate.

FIG. 12A illustrates the backside of the screen 512, including the damper 1100. As shown, the damper 1100 includes a face 1200 positioned offset from the cored-out region 1000 (i.e., in an open position allowing airflow through the cored-out region 1000). However, upon release of the fusible link 1004 during a thermal event inside the interior volume 500, the face 1200 can laterally (e.g., horizontally) slide in front of the cored-out region 1000 to a closed position to block airflow through the cored-out region 1000. In some examples, the face 1200 can form a seal against the interior surface of the battery cabinet 102 (e.g., such that the face 1200 is flush with the interior surface of the battery cabinet 102 to better reduce or prevent airflow between the air convection port 510 and the interior volume of the battery cabinet 102).

Being a horizontal sliding motion, springs 1206 can be utilized to actively bias (e.g., spring load) the damper 1100 toward the closed position in front of the cored-out region 1000. To provide such a bias, the springs 1206 can connect brackets 1202, 1204 (of the damper 1100) to corresponding connectors 1208 positioned on an opposite side of the cored-out region 1000. In making this connection, the springs 1206 can exert a constant tension upon the brackets 1202, 1204 (e.g., a spring force pulling in a direction toward the connectors 1208). As mentioned above, such active biasing of the damper 1100 can circumvent common issues (e.g., corrosion, debris build-up, etc.) with gravity-based dampers that can lend to failed damper activation. However, it will be appreciated that, in some embodiments, a damper of the present disclosure can be aided by gravity (in addition to active-biasing elements like springs).

FIG. 12B illustrates the damper 1100, with the screen 512 removed for purposes of illustration. As shown in FIG. 12B, the damper 1100 can be positioned adjacent to an inlet/outlet 1210 in fluid communication with the air convection port 510. Flame arrestors at the inlet/outlet 1210 are also removed for purposes of illustration in FIG. 12B (but are shown in FIG. 12C). Once the fusible link 1004 is activated (or released from the damper bracket 1108), the damper 1100 can slide horizontally in front of the inlet/outlet 1210 to inhibit air flow between the air convection port 510 and the interior volume of the battery cabinet 102. In certain examples, the face 1200 (shown in FIG. 12A) is also flush against a surface 1212 defining the interior volume of the battery cabinet 102, thereby providing a seal (e.g., a partial seal, an air seal, a hermetic seal, etc.) to inhibit airflow and reduce air escape. In at least one example, one or more surfaces of the damper 1100 is corrosion resistant (e.g., with galvanized material) to maintain component integrity and to help ensure the damper 1100 can slide in front of the inlet/outlet 1210 and provide the desired airflow blockage.

In some examples, the inlet/outlet 1210 is sized and shaped to provide increased airflow through the battery cabinet 102. For instance, the inlet/outlet 1210 is sized and shaped to allow sufficient airflow through the battery cabinet 102 to maintain the interior volume of the battery cabinet 102 at or below a threshold temperature (e.g., at about 60 degrees fahrenheit to about 150 degrees fahrenheit, about 80 degrees fahrenheit to about 120 degrees fahrenheit, or about 100 degrees fahrenheit). In this manner, batteries within the battery cabinet 102 can be cooled (particularly when charging). In at least one example, the inlet/outlet 1210 is sized and shaped to allow air throughput of about 60 cubic feet/minute (CFM) to about 400 CFM, about 80 CFM to about 200 CFM, about 100 CFM to about 150 CFM, or about 125 CFM.

FIG. 12C shows a close-up front view of the damper 1100 (particularly the face 1200) positioned adjacent to the surface 1212 of the battery cabinet 102). Additionally, FIG. 12C shows flame arrestors 1214, 1216 positioned adjacent to the air convection port 510 and flame arrestors 1218, 1220 positioned adjacent to the inlet/outlet 1210. The flame arrestors 1214-1220 can be secured in place (e.g., via fasteners) and can be the same as or similar to other flame arrestors disclosed herein. In some examples, the flame arrestors 1214-1220 can include a wire mesh screen rated for certain fire safety standards. In these or other examples, the flame arrestors 1214-1220 can absorb heat and/or stop flames from escaping the battery cabinet 102. Additionally, in some examples, the stacked arrangement of multiple flame arrestors (e.g., double-layered flame arrestors) can improve flame mitigation and/or satisfy certain fire safety standards.

Any of the features, components, and/or parts, including the arrangements and configurations thereof shown in FIGS. 10-12C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10-12C.

FIG. 13 illustrates a close-up view of a portion of the battery cabinet 102 (indicated in FIG. 9) where the door 408 meets the body of the battery cabinet 102. In particular, FIG. 13 illustrates how the flange 900 of the door 408 can abut (or be positioned adjacent to) the door jamb 902 (e.g., for a tight, protective closure). Although not shown, the intumescent seals 906 can also be implemented to provide additional sealing attributes.

As shown in FIG. 13, a path 1300 corresponds to a projected flame path in the event of a thermal failure or catastrophic termination of a battery inside the interior volume 500. As will now be discussed, the longer the path 1300 is, the less likely a flame will be able to traverse an entirety of the path 1300. Curvatures and/or bends at the abutment of the door 408 and the door jamb 902 can also be implemented to lengthen the path 1300, as well as introduce deflection points that can (in combination) weaken the combustive energy of a flame. For example, a first deflection point 1302 can correspond to the inner door wall of the door 408. Similarly, a second deflection point 1304 can correspond to the inner cabinet wall 702, and a third deflection point 1306 can correspond to the flange 900 of the door 408. Of course, in other embodiments, additional or alternative deflection points can be implemented.

As mentioned, the path 1300 can be lengthened in a variety of ways. In some examples, the distance between the deflection points 1304, 1306 can be increased by creating a larger span between inner and outer door walls of the door 408 (and correspondingly extending the door jamb 902 outward). In another example, a flange height 1308 of the flange 900 can be increased to lengthen the path 1300. Additionally, in some examples, the flange height 1308 can be extended above the outer cabinet wall 700, and the flange 900 can then be bent backwards so as to overlap the outer cabinet wall 700. In this manner, the flange 900 can be used to redirect any flames toward a wall or a safe direction away from users. An extended flange overlap relative to the outer cabinet wall 700 can also be used to weaken any combustive energy escaped from the interior volume 500.

Any of the features, components, and/or parts, including the arrangements and configurations thereof shown in FIG. 13 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 13.

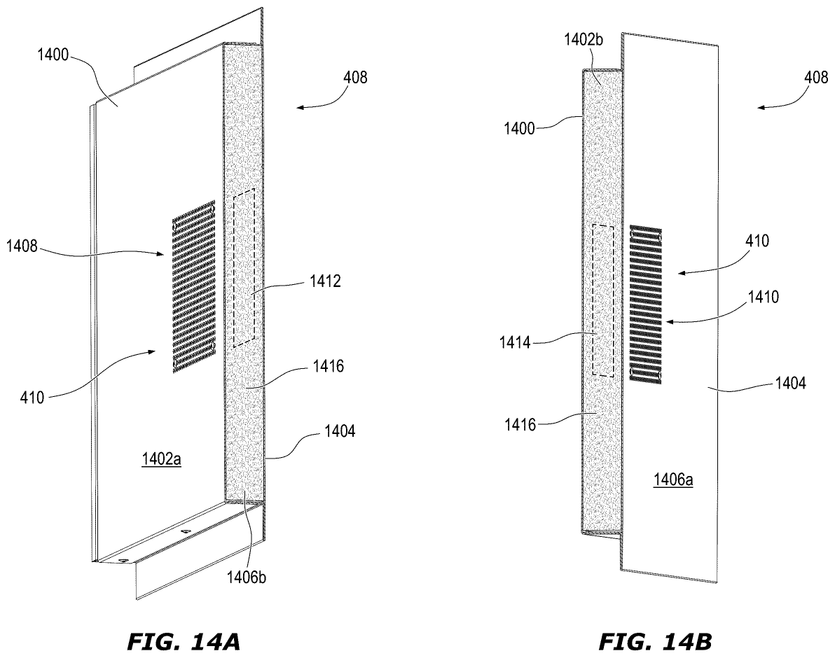

As discussed above, the doors of the battery cabinet 102 can be dual-purpose—for keeping a thermal runaway event contained within the battery cabinet 102, while also allowing for the controlled escape of pressurized gases. FIGS. 14A-14B respectively illustrate outside perspective and inside perspective cross-sectional views of the doors 408, in accordance with one or more examples of the present disclosure. As shown, the vents 410 (described above) can work in conjunction with certain door structure to depressurize the interior of the battery cabinet 102, while also keeping in (or reducing the effects of) a thermal runaway that may occur inside the battery cabinet 102. For example, the vents 410 can be positioned on both sides of the door 408. Specifically, the outside vent of the vents 410 can include apertures 1408 defined by a wall 1400, where the apertures 1408 extend through a surface 1402a (the exterior surface) to a surface 1402b (the interior surface) of the wall 1400. Similarly, the inside vent of the vents 410 can include apertures 1410 defined by a wall 1404, where the apertures 1410 extend through a surface 1406a (the exterior surface) to a surface 1406b (the interior surface) of the wall 1404. In these or other examples, the apertures 1410 and the apertures 1408 are fluidly connected to each other for the controlled passage of air therebetween.

In some examples, flame arrestors (described above) can be positioned adjacent to the vents 410. For example, a flame arrestor 1412 can be positioned against the surface 1406b of the wall 1404 and adjacent to the apertures 1410. As another example, a flame arrestor 1414 can be positioned against the surface 1402b of the wall 1400 and adjacent to the apertures 1408. Thus, a flame arrestor can be positioned at each vent of the vents 410. In some examples, more or fewer flame arrestors can be implemented.

In at least one example, filter media 1416 can be positioned between the flame arrestors 1412, 1414. The filter media 1416 can include various different types of filtration materials. The filter media 1416 can include, for example, a toxin absorber, scent control material, smoke inhibitor, flame retardant, insulation, etc. In a specific implementation, the filter media 1416 can include mineral wool. In one or more examples, the mineral wool (or other filter media) can filter any off-gassing through the vents 410 that may occur during a thermal runaway event. The term “filter” can, in some examples, refer to a cleaning, capturing, or absorption of one or more elements. Additionally or alternatively, the term “filter” can, in some examples, refer to a passage impediment (e.g., a blockage material).

Any of the features, components, and/or parts, including the arrangements and configurations thereof shown in FIGS. 14A-14B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 14A-14B.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.”

What is claimed is:

1. A double-walled battery charging cabinet, comprising:
an outer cabinet wall;
an inner cabinet wall spaced apart from the outer cabinet wall to form an insulating air gap between the inner cabinet wall and the outer cabinet wall, the inner cabinet wall defining an interior volume;
an air convection port disposed through the outer cabinet wall and the inner cabinet wall;
a flame arrestor positioned inside or adjacent to the air convection port;
a damper positioned adjacent to the air convection port;
a bias member to bias the damper toward a closed position;
a fusible link to hold the damper in an open position, the fusible link having a predetermined melting point at which the bias member causes the damper to slide horizontally from the open position to the closed position; and
a power outlet disposed inside the interior volume.

2. The double-walled battery charging cabinet of claim 1, where in the bias member comprises one or more spring members to bias the damper toward the closed position.

3. The double-walled battery charging cabinet of claim 1, further comprising a screen positioned adjacent to the air convection port, the screen comprising a cored-out region for air flow through the screen.

4. The double-walled battery charging cabinet of claim 3, wherein:
the screen defines a slotted portion; and
the damper comprises a bracket extending through the slotted portion to engage the fusible link.

5. The double-walled battery charging cabinet of claim 1, further comprising:
a door and a corresponding door jamb enclosing the interior volume; and
an intumescent seal disposed around at least one of the door or the door jamb.

6. The double-walled battery charging cabinet of claim 5, wherein the door comprises:
a first vent and a second vent; and
filter media disposed between the first vent and the second vent.

7. The double-walled battery charging cabinet of claim 1, wherein the air convection port comprises an air inlet, and the double-walled battery charging cabinet further comprises an additional air convection port that includes an air outlet.

8. The double-walled battery charging cabinet of claim 1, wherein the air convection port comprises a fan.

9. The double-walled battery charging cabinet of claim 1, further comprising at least one of feet or legs to support the double-walled battery charging cabinet on a surface.

10. A battery charging cabinet, comprising:
a reinforced wall defining an interior volume;
a shelf disposed within the interior volume and dividing the interior volume into at least a first portion and a second portion;
an air inlet disposed through the reinforced wall for airflow into the first portion at a first end of the battery charging cabinet;
an air outlet disposed through the reinforced wall for airflow out of the second portion at a second end of the battery charging cabinet opposite the first end; and
a spring-loaded damper positioned adjacent to each of the air inlet and the air outlet, the spring-loaded damper being slidable between open and closed positions.

11. The battery charging cabinet of claim 10, wherein the reinforced wall comprises a first wall layer and a second wall layer.

12. The battery charging cabinet of claim 11, further comprising an air gap between the first wall layer and the second wall layer.

13. The battery charging cabinet of claim 10, further comprising a fusible link to hold the spring-loaded damper in the open position when the fusible link is exposed to temperatures in the interior volume that are less than a predetermined temperature.

14. The battery charging cabinet of claim 10, further comprising a flame arrestor positioned inside or adjacent to at least the air inlet.

15. The battery charging cabinet of claim 10, further comprising a power outlet disposed in at least one of the first portion or the second portion of the interior volume.

16. A battery cabinet, comprising:
an outer cabinet wall;
an inner cabinet wall spaced apart from the outer cabinet wall to form an insulating air gap between the inner cabinet wall and the outer cabinet wall;
a pair of doors, wherein the inner cabinet wall and the pair of doors enclose an interior volume within the battery cabinet;
a pair of air convection ports disposed through the outer cabinet wall and the inner cabinet wall at opposing cabinet ends and at different heights within the interior volume, wherein at least one air convection port of the pair of air convection ports comprises a fan;
a flame arrestor positioned inside or adjacent to at least one air convection port of the pair of air convection ports;
a horizontally-slidable damper positioned adjacent to each air convection port of the pair of air convection ports, the horizontally-slidable damper being biased toward a closed position;
a fusible link to laterally hold the horizontally-slidable damper against the bias and in an open position based on a temperature within the interior volume; and
a power outlet disposed inside the interior volume.

17. The battery cabinet of claim 16, wherein each door of the pair of doors is double-walled.

18. The battery cabinet of claim 16, wherein each door of the pair of doors comprises a flange.

19. The battery cabinet of claim 16, further comprising a shelf dividing the interior volume into at least a first portion and a second portion, wherein cross-ventilation occurs between the first portion and the second portion during operation of the pair of air convection ports.

20. The battery cabinet of claim 16, wherein the each door of the pair of doors comprises:
an inner door vent and an outer door vent;
a first flame arrestor positioned adjacent to the inner door vent and a second flame arrestor positioned adjacent to the outer door vent; and
mineral wool positioned between the first flame arrestor and the second flame arrestor.
